(19) United States
(12) Patent Application Publication
(10) Pub. No.: US 2024/0144915 A1
(43) Pub. Date: May 2, 2024

(54) SPEECH RECOGNITION APPARATUS, SPEECH RECOGNITION METHOD, LEARNING APPARATUS, LEARNING METHOD, AND RECORDING MEDIUM

(71) Applicant: NEC CORPORATION, Minato-ku, Tokyo (JP)

(72) Inventors: Koji OKABE, Tokyo (JP); Hitoshi YAMAMOTO, Tokyo (JP)

(73) Assignee: NEC Corporation, Minato-ku, Tokyo (JP)

(21) Appl. No.: 18/279,134

(22) PCT Filed: Mar. 3, 2021
(86) PCT No.: PCT/JP2021/008106

§ 371 Date: Aug. 28, 2023

(51) Int. Cl. G10L 15/16; G10L 15/02

(52) U.S. Cl. CPC G10L 15/16; G10L 15/02; G10L 2015/025

(57) ABSTRACT

A speech recognition apparatus includes: an output unit that outputs a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and an update unit that updates the first probability on the basis of the second probability and dictionary data in which a registered character is associated with a registered phoneme that is a phoneme of the registered character.

### TECHNICAL FIELD

This disclosure relates, for example, to technical fields of a speech recognition apparatus and a speech recognition method that are capable of performing a speech recognition process by using a neural network that is configured to output the probability of a character sequence corresponding to a speech sequence indicated by speech data when the speech data are inputted, a learning apparatus and a learning method that are capable of learning parameters of a neural network that is configured to output the probability of a character sequence corresponding to a speech sequence indicated by speech data when the speech data are inputted, and a recording medium on which a computer program for executing a speech recognition method or a learning method is recorded.

### BACKGROUND ART

As an example of the speech recognition apparatus, there is known a speech recognition apparatus that performs a speech recognition process of converting speech data to a character sequence corresponding to a speech sequence indicated by the speech data, by using a statistical method. Specifically, the speech recognition apparatus that performs the speech recognition process by using the statistical method, performs the speech recognition process by using an acoustic model, a language model, and a pronunciation dictionary. The acoustic model is used to identify phonemes of speech/voice indicated by the speech data. As the acoustical model, for example, a Hidden Markov Model (HMM) is used. The language model is used to evaluate the ease of appearance of a word sequence corresponding to the speech sequence indicated by the speech data. The pronunciation dictionary represents restrictions on arrangement of phonemes, and is used to associate a word sequence of the language model with a phoneme sequence identified on the basis of the acoustic model.

On the other hand, recently, an End-to-End speech recognition apparatus has been developed rapidly. An example of the End-to-End speech recognition apparatus is described in Patent Literature 1. The End-to-End speech recognition apparatus is a speech recognition apparatus that performs a speech recognition process by using a neural network that outputs a character sequence corresponding to a speech sequence indicated by speech data when the speech data are inputted. Such an End-to-End speech recognition apparatus is configured to perform the speech recognition process without separately providing the acoustic model, the language model, and the pronunciation dictionary.

In addition, as prior art documents related to this disclosure, Patent Literature 2 to Patent Literature 4 are cited.

### CITATION LIST

### Patent Literature

Patent Literature 1: International Publication No. WO2018/066436 pamphlet
Patent Literature 2: JP2014-232510A
Patent Literature 3: JP2002-278584A
Patent Literature 4: JPH08-297499A

### SUMMARY

### Technical Problem

It is an example object of this disclosure to provide a speech recognition apparatus, a speech recognition method, a learning apparatus, a learning method, and a recording medium for the purpose of improving the techniques/technologies described in Citation List.

### Solution to Problem

A speech recognition apparatus according to an example aspect includes: an output unit that outputs a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and an update unit that updates the first probability on the basis of the second probability and dictionary data in which a registered character is associated with a registered phoneme that is a phoneme of the registered character.

A speech recognition method according to an example aspect includes: outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and updating the first probability on the basis of the second probability and dictionary data in which a registered character is associated with a registered phoneme that is a phoneme of the registered character.

A learning apparatus according to an example aspect includes: an acquisition unit that obtains training data including first speech data for learning, a ground truth label of a first character sequence corresponding to a first speech sequence indicated by the first speech data, and a ground truth label of a first phoneme sequence corresponding to the first speech sequence; and a learning unit that learns parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

A learning method according to an example aspect includes: obtaining training data including first speech data for learning, a ground truth label of a first character sequence corresponding to a first speech sequence indicated by the first speech data, and a ground truth label of a first phoneme sequence corresponding to the first speech sequence; and learning parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

A recording medium according to a first example aspect is a recording medium on which a computer program that allows a computer to execute a speech recognition method is recorded, the speech recognition method including: outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and updating the first probability on the basis of the second probability and dictionary data in which a registered character is associated with a registered phoneme that is a phoneme of the registered character.

A recording medium according to a second example aspect is a recording medium on which a computer program that allows a computer to execute a learning method is recorded, the learning method including: obtaining training data including first speech data for learning, a ground truth label of a first character sequence corresponding to a first speech sequence indicated by the first speech data, and a ground truth label of a first phoneme sequence corresponding to the first speech sequence; and learning parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

### BRIEF DESCRIPTION OF DRAWINGS

FIG. 1 is a block diagram illustrating a configuration of a speech recognition apparatus according to an example embodiment.

FIG. 2 is a table illustrating an example of a character probability outputted by the speech recognition apparatus according to the example embodiment.

FIG. 3 is a table illustrating an example of a phoneme probability outputted by the speech recognition apparatus according to the example embodiment.

FIG. 4 is a data structure diagram illustrating an example of a data structure of dictionary data used by the speech recognition apparatus according to the example embodiment.

FIG. 5 is a flowchart illustrating a flow of a speech recognition process performed by the speech recognition apparatus.

FIG. 6 is a table illustrating a maximum likelihood phoneme (i.e., a phoneme with the highest phoneme probability) at a certain time.

FIG. 7 is a table illustrating the character probability before being updated by the speech recognition apparatus.

FIG. 8 is a table illustrating the character probability after being updated by the speech recognition apparatus.

FIG. 9 is a block diagram illustrating a configuration of a speech recognition apparatus according to a modified example.

FIG. 10 is a block diagram illustrating a configuration of a learning apparatus according to the example embodiment.

FIG. 11 is a data structure diagram illustrating an example of a data structure of training data used by the learning apparatus according to the example embodiment.

### DESCRIPTION OF EXAMPLE EMBODIMENT

Hereinafter, a speech recognition apparatus, a speech recognition method, a learning apparatus, a learning method, and a recording medium according to an example embodiment will be described. The following describes the speech recognition apparatus and the speech recognition method according to the example embodiment (and furthermore, the recording medium according to the example embodiment on which a computer program that allows a computer to execute the speech recognition method is recorded), by using a speech recognition apparatus 1, and then describes the learning apparatus and the learning method according to the example embodiment (and furthermore, the recording medium according to the example embodiment on which a computer program that allows a computer to execute the learning method is recorded), by using a learning apparatus 2.

### (1) Speech Recognition Apparatus 1 in Example Embodiment

First, the speech recognition apparatus 1 in the example embodiment will be described. The speech recognition apparatus 1 is configured to perform a speech recognition process to identify a character sequence and a phoneme sequence corresponding to a speech sequence indicated by speech data, on the basis of the speech data. The speech sequence may mean a time series of speech/voice spoken by a speaker (i.e., a temporal change in the speech/voice, and an observation result obtained by continuously or discontinuously observing the temporal change in the speech/voice). The character sequence may mean a time series of characters corresponding to the speech/voice spoken by the speaker (i.e., a temporal change in the characters corresponding to the speech/voice, and a character set including a series of multiple characters). The phoneme sequence may mean a time series of phonemes corresponding to the speech/voice spoken by the speaker (i.e., a temporal variation in the phonemes corresponding to the speech/voice, and a phoneme set including a series of multiple phonemes).

A configuration and operation of the speech recognition apparatus 1 that is configured to perform such a speech recognition process will be described below in order.

(1-1) Configuration of Speech recognition Apparatus 1

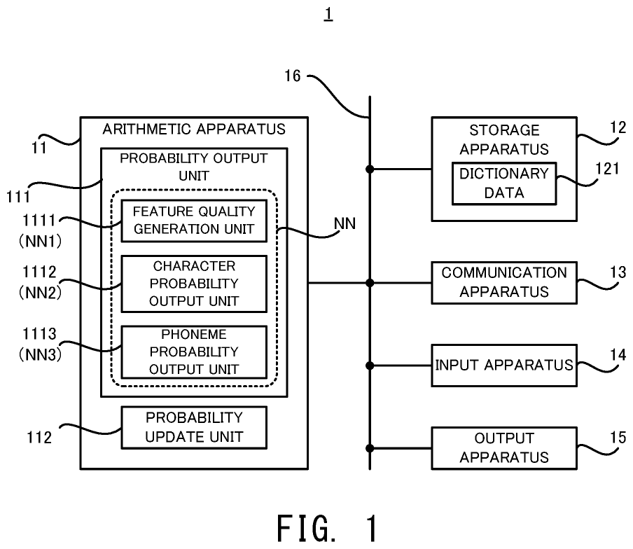

First, the configuration of the speech recognition apparatus 1 in the example embodiment will be described with reference to FIG. 1. FIG. 1 is a block diagram illustrating the configuration of the speech recognition apparatus 1 according to the example embodiment. As illustrated in FIG. 1, the speech recognition apparatus 1 includes an arithmetic apparatus 11 and a storage apparatus 12. Furthermore, the speech recognition apparatus 1 may include a communication apparatus 13, an input apparatus 14, and an output apparatus 15. Contrarily, the speech recognition apparatus 1 may not include the communication apparatus 13. The speech recognition apparatus 1 may not include the input apparatus 14. The speech recognition apparatus 1 may not include the output apparatus 15. The arithmetic apparatus 11, the storage apparatus 12, the communication apparatus 13, the input apparatus 14, and the output apparatus 15 may be connected through a data bus 16.

The arithmetic apparatus 11 may include, for example, a CPU (Central Processing Unit). The arithmetic apparatus 11 may include, for example, a GPU (Graphics Processing Unit) in addition to or instead of the CPU. The arithmetic apparatus 11 may include, for example, a FPGA (Field Programmable Gate Array) in addition to or instead of at least one of the CPU and the GPU. The arithmetic apparatus 11 reads a computer program. For example, the arithmetic apparatus 11 may read a computer program stored in the storage apparatus 12. For example, the arithmetic apparatus 11 may read a computer program stored by a computer-readable and non-transitory recording medium, by using a recording medium reading apparatus provided in the speech recognition apparatus 1 (e.g., the input apparatus 14 described later). The arithmetic apparatus 11 may obtain (i.e., read) a computer program from a not-illustrated apparatus (e.g., a server) disposed outside the speech recognition apparatus 1, through the communication apparatus 13. That is, the arithmetic apparatus 11 may download a computer program. The arithmetic apparatus 11 executes the read computer program. Consequently, a logical functional block for performing an operation to be performed by the speech recognition apparatus 1 (e.g., the above-described speech recognition process) is realized or implemented in the arithmetic apparatus 11. That is, the arithmetic apparatus 11 is allowed to function as a controller for realizing or implementing the logical function block for performing the process to be performed by the speech recognition apparatus 1.

FIG. 1 illustrates an example of the logical functional block realized or implemented in the arithmetic apparatus 11 to perform the speech recognition process. As illustrated in FIG. 1, in the arithmetic apparatus 11, a probability output unit 111 that is a specific example of an “output unit” and a probability update unit 112 that is a specific example of an “update unit” are realized or implemented.

The probability output unit 111 is configured to output (in other words, is configured to calculate) a character probability CP on the basis of the speech data. The character probability CP indicates the probability of the character sequence (in other words, a word sequence) corresponding to the speech sequence indicated by the speech data. More specifically, the character probability CP indicates a posterior probability P(W|X) in which when a feature quantity of the speech sequence indicated by the speech data is X, the character sequence corresponding to the speech sequence is a character sequence W. The character sequence is a time series indicating notation by the characters of the speech sequence. For this reason, the character sequence may be referred to as a notation sequence. Furthermore, the character sequence may be a word set including a series of multiple words. In this case, the character sequence may be referred to as a word sequence.

When the speech data indicate a Japanese speech sequence, the character sequence may include Japanese Kanji. That is, the character sequence may be a time series including Japanese Kanji. When the speech data indicate the Japanese speech sequence, the character sequence may include Hiragana. That is, the character sequence may be a time series including Hiragana.

When the speech data indicates the Japanese speech sequence, the character sequence may include Katakana. That is, the character sequence may be a time series including Katakana. The character sequence may include a number. Japanese Kanji is an example of a logogram. For this reason, the character sequence may include the logogram. That is, the character sequence may be a time series including the logogram. The character sequence may include the logogram not only when the speech data indicate the Japanese speech sequence, but also when the speech data indicate a speech sequence in a language that is different from Japanese. Each of Hiragana and Katakana is an example of a phonogram. For this reason, the character sequence may include the phonogram. That is, the character sequence may be a time series including the phonogram. The character sequence may include the phonogram not only when the speech data indicate the Japanese speech sequence, but also when the speech data indicate the speech sequence in the language that is different from Japanese.

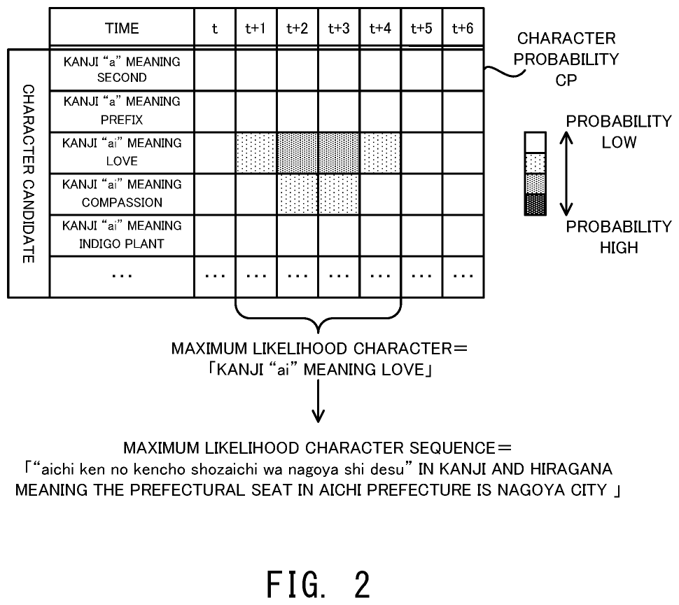

FIG. 2 illustrates an example of the character probability CP. As illustrated in FIG. 2, the probability output unit 111 may output the character probability CP including the probability that a character corresponding to voice at a certain time is a particular character candidate. In the example illustrated in FIG. 2, the probability output unit 111 outputs the character probability CP including: (i) the probability that a character corresponding to voice at a time t is a first character candidate (a first Japanese Kanji “a” meaning “second” in the example illustrated in FIG. 2); (ii) the probability that the character corresponding to the voice at the time t is a second character candidate that is different from the first character candidate (a second Japanese Kanji “a” prefixed to a person's name to show intimacy in the example illustrated in FIG. 2); (iii) the probability that the character corresponding to the voice at the time t is a third character candidate that is different from the first and second character candidates (a third Japanese Kanji “ai” meaning “love” and “adore” in the example illustrated in FIG. 2); (iv) the probability that the character corresponding to the voice at the time t is a fourth character candidate that is different from the first to third character candidates (a fourth Japanese Kanji “ai” meaning “compassion” in the example illustrated in FIG. 2,); (v) the probability that the character corresponding to the voice at the time t is a fifth character candidate that is different from the first to fourth character candidates (a fifth Japanese Kanji “ai” meaning “a type of an annual grass of the family Polygonaceae, or indigo plant” in the example illustrated in FIG. 2); and so on.

Furthermore, since the speech data are the time series data indicating the speech sequence, the probability output unit 111 may output the character probability CP including the probability that a character corresponding to voice at each of a plurality of different times is a particular character candidate. That is, the probability output unit 111 may output the character probability CP including a time series of the probability that a character corresponding to voice at a certain time is a particular character candidate. In the example illustrated in FIG. 2, the probability output unit 111 may output the character probability CP including: (i) a time series of the probability that the character corresponding to the speech/voice is the first character candidate (e.g., (i−1) the probability that the character corresponding to the voice at the time t is the first character candidate, (i−2) the probability that a character corresponding to voice at a time t+1 following the time t is the first character candidate, (i−3) the probability that a character corresponding to voice at a time t+2 following the time t+1 is the first character candidate, (i−4) the probability that a character corresponding to voice at a time t+3 following the time t+2 is the first character candidate, (i−5) the probability that a character corresponding to voice at a time t+4 following the time t+3 is the first character candidate, (i−6) the probability that a character corresponding to voice at a time t+5 following the time t+4 is the first character candidate, and (i−7) the probability that a character corresponding to voice at a time t+6 following the time t+5 is the first character candidate); (ii) a time series of the probability that the character corresponding to the speech/voice is the second character candidate (e.g., (ii−1) the probability that the character corresponding to the voice at the time t is the second character candidate, (ii−2) the probability that the character corresponding to the voice at the time t+1 following the time t is the second character candidate, (ii−3) the probability that the character corresponding to the voice at the time t+2 following the time t+1 is the second character candidate, (ii−4) the probability that the character corresponding to the voice at the time t+3 following the time t+2 is the second character candidate, (ii−5) the probability that the character corresponding to the voice at the time t+4 following the time t+3 is the second character candidate, (ii−6) the probability that the character corresponding to the voice at the time t+5 following the time t+4 is the second character candidate, and (ii−7) the probability that the character corresponding to the voice at the time t+6 following the time t+5 is the second character candidate); (iii) a time series of the probability that the character corresponding to the speech/voice is the third character candidate (e.g., (iii−1) the probability that the character corresponding to the voice at the time t is the third character candidate, (iii−2) the probability that the character corresponding to the voice at the time t+1 following the time t is the third character candidate, (iii−3) the probability that the character corresponding to the voice at the time t+2 following the time t+1 is the third character candidate, (iii−4) the probability that the character corresponding to the voice at the time t+3 following the time t+2 is the third character candidate, (iii−5) the probability that the character corresponding to the voice at the time t+4 following the time t+3 is the third character candidate, (iii−6) the probability that the character corresponding to the voice at the time t+5 following the time t+4 is the third character candidate, and (iii−7) the probability that the character corresponding to the voice at the time t+6 following the time t+5 is the third character candidate); (iv) a time series of the probability that the character corresponding to the speech/voice is the fourth character candidate (e.g., (iv−1) the probability that the character corresponding to the voice at the time t is the fourth character candidate, (iv−2) the probability that the character corresponding to the voice at the time t+1 following the time t is the fourth character candidate, (iv−3) the probability that the character corresponding to the voice at the time t+2 following the time t+1 is the fourth character candidate, (iv−4) the probability that the character corresponding to the voice at the time t+3 following the time t+2 is the fourth character candidate, (iv−5) the probability that the character corresponding to the voice at the time t+4 following the time t+3 is the fourth character candidate, (iv−6) the probability that the character corresponding to the voice at the time t+5 following the time t+4 is the fourth character candidate, and (iv−7) the probability that the character corresponding to the voice at the time t+6 following the time t+5 is the fourth character candidate); (v) a time series of the probability that the character corresponding to the speech/voice is the fifth character candidate (e.g., (v−1) the probability that the character corresponding to the voice at the time t is the fifth character candidate, (v−2) the probability that the character corresponding to the voice at the time t+1 following the time t is the fifth character candidate, (v−3) the probability that the character corresponding to the voice at the time t+2 following the time t+1 is the fifth character candidate, (v−4) the probability that the character corresponding to the voice at the time t+3 following the time t+2 is the fifth character candidate, (v−5) the probability that the character corresponding to the voice at the time t+4 following the time t+3 is the fifth character candidate, (v−6) the probability that the character corresponding to the voice at the time t+5 following the time t+4 is the fifth character candidate, and (v−7) the probability that the character corresponding to the voice at the time t+6 following the time t+5 is the fifth character candidate); and so on.

In the example illustrated in FIG. 2, in order to emphasize visibility of the drawing, the magnitude of the probability that the character corresponding to the voice at the certain time is the particular character candidate, is expressed by the presence or absence of hatching of a cell indicating the probability and the density of the hatching. Specifically, in the example illustrated in FIG. 2, the magnitude of the probability is expressed by the presence or absence of hatching of the cell and the density of the hatching such that the probability indicated by the cell becomes higher as the density of the hatching of the cell becomes higher (i.e., the probability indicated by the cell becomes lower as the density of the hatching of the cell becomes lower).

The speech recognition apparatus 1 (especially, the arithmetic apparatus 11) may identify a most probable character sequence as the character sequence corresponding to the speech sequence indicated by the speech data, on the basis of the character probability CP outputted by the probability output unit 111. In the following description, the most probable character sequence is referred to as a “maximum likelihood character sequence”. In this case, the arithmetic apparatus 11 may include a not-illustrated character sequence identification unit for identifying the maximum likelihood character sequence. The maximum likelihood character sequence identified by the character sequence identification unit may be outputted from the arithmetic apparatus 11 as a result of the speech recognition process.

For example, the speech recognition apparatus 1 (especially, the arithmetic apparatus 11 and the character sequence identification unit) may identify a character sequence with the highest character probability CP (i.e., a character sequence corresponding to a maximum likelihood path connecting character candidates with the highest character probability CP in a time-series order), as the maximum likelihood character sequence corresponding to the speech sequence indicated by the speech data. For example, in the example illustrated in FIG. 2, the character probability CP indicates that the probability that the character corresponding to the voice at each of the time t+1 to the time t+4 is the third character candidate (the third Japanese Kanji “ai” meaning love in the example illustrated in FIG. 2) is the highest. In this case, the speech recognition apparatus 1 (especially, the arithmetic apparatus 11) may select the third character candidate as a most probable character (i.e., a maximum likelihood character) corresponding to the voice at each of the time t+1 to the time t+4. Subsequently, the speech recognition apparatus 1 (especially, the arithmetic apparatus 11) may repeat the same operation at each time, thereby to select the maximum likelihood character corresponding to the voice at each time. Consequently, the speech recognition apparatus 1 (especially, the arithmetic apparatus 11) may identify a character sequence in which the maximum likelihood characters selected at respective times are arranged in a time-series order, as the maximum likelihood character sequence corresponding to the speech sequence indicated by the speech data. In the example illustrated in FIG. 2, the speech recognition apparatus 1 (especially, the arithmetic apparatus 11) identifies a character sequence in Japanese Kanji and Hiragana “aichi ken no kencho shozaichi wa nagoya shi desu” meaning “The prefectural seat in Aichi Prefecture is Nagoya City”, as the maximum likelihood character sequence corresponding to the speech sequence indicated by the speech data. In this way, the speech recognition apparatus 1 (specifically, the arithmetic apparatus 11) is allowed to identify the character sequence corresponding to the speech sequence indicated by the speech data.

The probability output unit 111 is further configured to output (in other words, calculate) a phoneme probability PP, in addition to the character probability CP, on the basis of the speech data. The phoneme probability PP indicates the probability of the phoneme sequence corresponding to the speech sequence indicated by the speech data. More specifically, the phoneme probability PP indicates a posterior probability P(S|X) in which when the feature quantity of the speech sequence indicated by the speech data is X, the phoneme sequence corresponding to the speech sequence is a phoneme sequence S. The phoneme sequence is a time series data including a reading (i.e., a vocal sound or phonemes with a broader meaning) of the character sequence corresponding to the speech sequence. For this reason, the phoneme sequence may be referred to as a reading sequence or a vocal sound sequence.

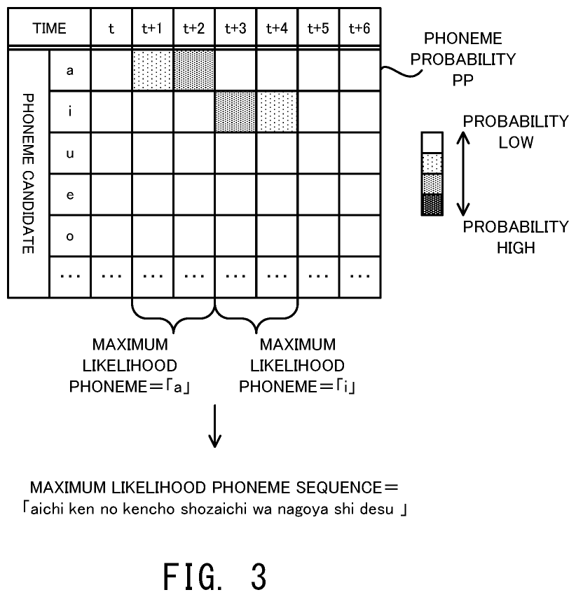

When the speech data indicate Japanese speech/voice, the phoneme sequence may include Japanese phonemes. For example, the phoneme sequence may include Japanese phonemes written in Hiragana or Katakana. That is, the phoneme sequence may include Japanese phonemes written by using a syllabic script called Hiragana or Katakana. Alternatively, the phoneme sequence may include Japanese phonemes written in alphabet. That is, the phoneme sequence may include Japanese phonemes written by using a segmental script called alphabet. The Japanese phonemes written in alphabet may include phonemes of vowels including “a”, “i”, “u”, “e” and “o”. The Japanese phonemes written in alphabet may include phonemes of consonants including “k”, “s”, “t”, “n”, “h”, “m”, “y”, “r”, “g”, “z”, “d”, “b” and “p”. The Japanese phonemes written in alphabet may include phonemes of semivowels including “j” and “w.” The Japanese phonemes written in alphabet may include special mora phonemes including “N,” “Q,” and “H.” FIG. 3 illustrates an example of the phoneme probability PP. As illustrated in FIG. 3, the probability output unit 111 may output the phoneme probability PP including the probability that a phoneme corresponding to voice at a certain time is a particular phoneme candidate. In the example illustrated in FIG. 3, the probability output unit 111 outputs the phoneme probability PP including: (i) the probability that a phoneme corresponding to voice at a time t is a first phoneme candidate (a first phoneme “a” (a first phoneme “a” in alphabet in the example illustrated in FIG. 3)); (ii) the probability that the phoneme corresponding to the voice at the time t is a second phoneme candidate that is different from the first phoneme candidate (a second phoneme “i” (a second phoneme “i” in alphabet in the example illustrated in FIG. 3)); (iii) the probability that the phoneme corresponding to the voice at the time t is a third phoneme candidate that is different from the first and second phoneme candidates (a third phoneme “u” (a third phoneme “u” in alphabet in the example illustrated in FIG. 3)); (iv) the probability that the phoneme corresponding to the voice at the time t is a fourth phoneme candidate that is different from the first to third phoneme candidates (a fourth phoneme “e” (a fourth phoneme “e” in alphabet in the example illustrated in FIG. 3)); (v) the probability that the phoneme corresponding to the voice at the time t is a fifth phoneme candidate that is different from the first to fourth phoneme candidates (a fifth phoneme “o” (a fifth phoneme “o” in alphabet in the example illustrated in FIG. 3)); and so on.

Furthermore, since the speech data are time series data indicating the speech sequence, the probability output unit 111 may output the phoneme probability PP including the probability that a phoneme corresponding to voice at each of a plurality of different times is a particular phoneme candidate. That is, the probability output unit 111 may output the phoneme probability PP including a time series of the probability that a phoneme corresponding to voice at a certain time is a particular phoneme candidate. In the example illustrated in FIG. 3, the probability output unit 111 outputs the phoneme probability PP including: (i) a time series of the probability that the phoneme corresponding to the speech/voice is the first phoneme candidate (e.g., (i−1) the probability that the phoneme corresponding to the voice at the time t is the first phoneme candidate, (i−2) the probability that a phoneme corresponding to voice at a time t+1 following the time t is the first phoneme candidate, (i−3) the probability that a phoneme corresponding to voice at a time t+2 following the time t+1 is the first phoneme candidate, (i−4) the probability that a phoneme corresponding to voice at a time t+3 following the time t+2 is the first phoneme candidate, (i−5) the probability that a phoneme corresponding to voice at a time t+4 following the time t+3 is the first phoneme candidate, (i−6) the probability that a phoneme corresponding to voice at a time t+5 following the time t+4 is the first phoneme candidate, and (i−7) the probability that a phoneme corresponding to voice at a time t+6 following the time t+5 is the first phoneme candidate); (ii) a time series of the probability that the phoneme corresponding to the speech/voice is the second phoneme candidate (e.g., (ii−1) the probability that the phoneme corresponding to the voice at the time t is the second phoneme candidate, (ii−2) the probability that the phoneme corresponding to the voice at the time t+1 following the time t is the second phoneme candidate, (ii−3) the probability that the phoneme corresponding to the voice at the time t+2 following the time t+1 is the second phoneme candidate, (ii−4) the probability that the phoneme corresponding to the voice at the time t+3 following the time t+2 is the second phoneme candidate, (ii−5) the probability that the phoneme corresponding to the voice at the time t+4 following the time t+3 is the second phoneme candidate, (ii−6) the probability that the phoneme corresponding to the voice at the time t+5 following the time t+4 is the second phoneme candidate, and (ii−7) the probability that the phoneme corresponding to the voice at the time t+6 following the time t+5 is the second phoneme candidate); (iii) a time series of the probability that the phoneme corresponding to the speech/voice is the third phoneme candidate (e.g., (iii−1) the probability that the phoneme corresponding to the voice at the time t is the third phoneme candidate, (iii−2) the probability that the phoneme corresponding to the voice at the time t+1 following the time t is the third phoneme candidate, (iii−3) the probability that the phoneme corresponding to the voice at the time t+2 following the time t+1 is the third phoneme candidate, (iii−4) the probability that the phoneme corresponding to the voice at the time t+3 following the time t+2 is the third phoneme candidate, (iii−5) the probability that the phoneme corresponding to the voice at the time t+4 following the time t+3 is the third phoneme candidate, (iii−6) the probability that the phoneme corresponding to the voice at the time t+5 following the time t+4 is the third phoneme candidate, and (iii−7) the probability that the phoneme corresponding to the voice at the time t+6 following the time t+5 is the third phoneme candidate); (iv) a time series of the probability that the phoneme corresponding to the speech/voice is the fourth phoneme candidate (e.g., (iv−1) the probability that the phoneme corresponding to the voice at the time t is the fourth phoneme candidate, (iv−2) the probability that the phoneme corresponding to the voice at the time t+1 following the time t is the fourth phoneme candidate, (iv−3) the probability that the phoneme corresponding to the voice at the time t+2 following the time t+1 is the fourth phoneme candidate, (iv−4) the probability that the phoneme corresponding to the voice at the time t+3 following the time t+2 is the fourth phoneme candidate, (iv−5) the probability that the phoneme corresponding to the voice at the time t+4 following the time t+3 is the fourth phoneme candidate, (iv−6) the probability that the phoneme corresponding to the voice at the time t+5 following the time t+4 is the fourth phoneme candidate, and (iv−7) the probability that the phoneme corresponding to the voice at the time t+6 following the time t+5 is the fourth phoneme candidate); (v) a time series of the probability that the phoneme corresponding to the speech/voice is the fifth phoneme candidate (e.g., (v−1) the probability that the phoneme corresponding to the voice at the time t is the fifth phoneme candidate, (v−2) the probability that the phoneme corresponding to the voice at the time t+1 following the time t is the fifth phoneme candidate, (v−3) the probability that the phoneme corresponding to the voice at the time t+2 following the time t+1 is the fifth phoneme candidate, (v−4) the probability that the phoneme corresponding to the voice at the time t+3 following the time t+2 is the fifth phoneme candidate, (v−5) the probability that the phoneme corresponding to the voice at the time t+4 following the time t+3 is the fifth phoneme candidate, (v−6) the probability that the phoneme corresponding to the voice at the time t+5 following the time t+4 is the fifth phoneme candidate, and (v−7) the probability that the phoneme corresponding to the voice at the time t+6 following the time t+5 is the fifth phoneme candidate); and so on.

In the example illustrated in FIG. 3, in order to emphasize visibility of the drawing, the magnitude of the probability that the phoneme corresponding to the voice at the certain time is the particular phoneme candidate, is expressed by the presence or absence of hatching of a cell indicating the probability and the density of the hatching. Specifically, in the example illustrated in FIG. 3, the magnitude of the probability is expressed by the presence or absence of hatching of the cell and the density of the hatching such that the probability indicated by the cell becomes higher as the density of the hatching of the cell becomes higher (i.e., the probability indicated by the cell becomes lower as the density of the hatching of the cell becomes lower).

The speech recognition apparatus 1 (especially, the arithmetic apparatus 11) may identify a most probable phoneme sequence as the phoneme sequence corresponding to the speech sequence indicated by the speech data, on the basis of the phoneme probability PP outputted by the probability output unit 111. In the following description, the most probable phoneme sequence is referred to as a “maximum likelihood phoneme sequence”. In this case, the arithmetic apparatus 11 may include a not-illustrated phoneme sequence identification unit for identifying the maximum likelihood phoneme sequence. The maximum likelihood phoneme sequence identified by the phoneme sequence identification unit may be outputted from the arithmetic apparatus 11 as a result of the speech recognition process.

For example, the speech recognition apparatus 1 (especially, the arithmetic apparatus 11 and the phoneme sequence identification unit) may identify a phoneme sequence with the highest phoneme probability PP (i.e., a phoneme sequence corresponding to a maximum likelihood path connecting phoneme candidates with the highest phoneme probability PP in a time-series order), as the maximum likelihood phoneme sequence corresponding to the speech sequence indicated by the speech data. For example, in the example illustrated in FIG. 3, the phoneme probability PP indicates that the probability that the phoneme corresponding to the voice at each of the time t+1 and the time t+2 is the first phoneme candidate (the first phoneme “a” (the first phoneme “a” in alphabet) in the example illustrated in FIG. 3) is the highest. In this case, the speech recognition apparatus 1 may select the first phoneme candidate as a most probable phoneme (i.e., a maximum likelihood phoneme) corresponding to the voice at each of the time t+1 and the time t+2. Furthermore, in the example illustrated in FIG. 3, the phoneme probability PP indicates that the probability that the phoneme corresponding to the voice at each of the time t+3 and the time t+4 is the second phoneme candidate (the second phoneme “i” (the second phoneme “i” in alphabet) in the example illustrated in FIG. 3) is the highest. In this case, the speech recognition apparatus 1 may select the second phoneme candidate as a maximum likelihood phoneme corresponding to the voice at each of the time t+3 and the time t+4. Subsequently, the speech recognition apparatus 1 may repeat the same operation at each time, thereby to select the maximum likelihood phoneme corresponding to the voice at each time. Consequently, the speech recognition apparatus 1 may identify a phoneme sequence in which the maximum likelihood phonemes selected at respective times are arranged in a time-series order, as the maximum likelihood phoneme sequence corresponding to the speech indicated by the speech data. In the example illustrated in FIG. 3, the speech recognition apparatus 1 identifies a phoneme sequence “Aichi ken no kencho shozaichi wa Nagoya shi desu (a-i-chi-ke-n-no-ke-n-cho-syo-za-i-chi-ha-na-go-ya-shi-de-su in alphabet)”, as the maximum likelihood phoneme sequence corresponding to the speech sequence indicated by the speech data. In this way, the speech recognition apparatus 1 is allowed to identify the phoneme sequence corresponding to the speech sequence indicated by the speech data.

In the example embodiment, the probability output unit 111 outputs each of the character probability CP and the phoneme probability PP by using a neural network NN. For this reason, the neural network NN may be realized or implemented in the arithmetic apparatus 11. The neural network NN is configured to output each of the character probability CP and the phoneme probability PP when the speech data (e.g., speech data subjected to Fourier transform) are inputted. For this reason, the speech recognition apparatus 1 in this example embodiment is an End-to-End speech recognition apparatus.

The neural network NN may be a neural network using CTC (Connectionist Temporal Classification). The neural network using CTC may be a RNN (Recurrent Neural network) that reduces output sequences of a plurality of LSTMs (Long Short Term Memory), by using the plurality of LSTMs that use a subword including the phoneme and the character as an output unit. Alternatively, the neural network NN may be an Encoder-Attention-Decoder type neural network. The Encoder-Attention-Decoder type neural network is a neural network that encodes an input sequence (e.g., the speech sequence) by using the LSTM and then decodes the encoded input sequence to a subword sequence (e.g., the character sequence and the phoneme sequence). The neural network NN, however, may be different from the neural network using CTC and the neural network using Attention. For example, the neural network NN may be a CNN (Convolutional Neural Network). For example, the neural network NN may be a neural network using Self Attention.

The neural network NN may include a feature quantity generation unit 1111, a character probability output unit 1112, and a phoneme probability output unit 1113. That is, the neural network NN may include a first network part NN1 that is configured to function as the feature quantity generation unit 1111, a second network part NN2 that is configured to function as the character probability output unit 1112, and a third network part NN3 that is configured to function as the phoneme probability output unit 1113. The feature quantity generation unit 1111 is configured to generate the feature quantity of the speech sequence indicated by the speech data, on the basis of the speech data. The character probability output unit 1112 is configured to output (in other words, calculate) the character probability CP, on the basis of the feature quantity generated by the feature quantity generation unit 1111. The phoneme probability output unit 1113 is configured to output (in other words, calculate) the phoneme probability PP, on the basis of the feature quantity generated by the feature quantity generation unit 1111.

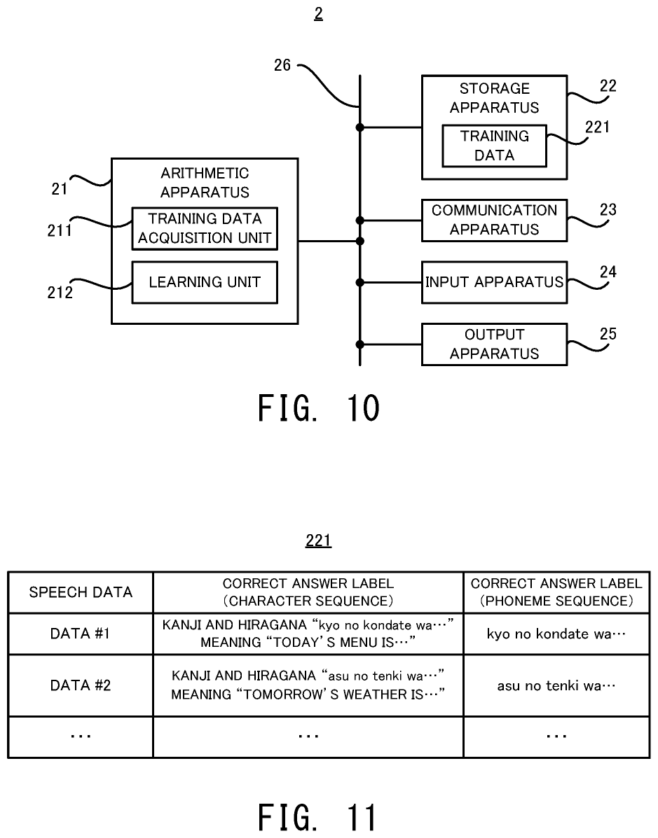

Parameters of the neural network NN may be learned (i.e., set or determined) by a learning apparatus 2 described later. For example, the learning apparatus 2 may learn the parameters of the neural network NN by using training data 221 (see FIG. 10 to FIG. 11 described later) including speech data for learning, a ground truth label of a character sequence corresponding to a speech sequence indicated by the speech data for learning, and a ground truth label of a phoneme sequence corresponding to the speech sequence indicated by the speech data for learning. The parameters of the neural network NN may include at least one of a weight by which an input value inputted to each node included in the neural network NN is multiplied, and a bias that is added, in each node, to an input value multiplied by the weight.

For example, the probability output unit 111 may output each of the character probability CP and the phoneme probability PP, by using a neural network that is configured to function as at least one of the feature quantity generation unit 1111, the character probability output unit 1112, and the phoneme probability output unit 1113, and a neural network that is configured to function as at least another of the feature quantity generation unit 1111, the character probability output unit 1112, and the phoneme probability output unit 1113, instead of the single neural network including the feature quantity generation unit 1111, the character probability output unit 1112, and the phoneme probability output unit 1113. That is, in the arithmetic apparatus 11, the neural network that is configured to function as at least one of the feature quantity generation unit 1111, the character probability output unit 1112, and the phoneme probability output unit 1113, and the neural network that is configured to function as at least another of the feature quantity generation unit 1111, the character probability output unit 1112, and the phoneme probability output unit 1113 may be realized or implemented separately. For example, the probability output unit 111 may output each of the character probability CP and the phoneme probability PP, by using a neural network that is configured to function as the feature quantity generation unit 1111 and the character probability output unit 1112, and a neural network that is configured to function as the phoneme probability output unit 1113. For example, the probability output unit 111 may output each of the character probability CP and the phoneme probability PP, by using a neural network that is configured to function as the feature quantity generation unit 1111, a neural network that is configured to function as the character probability output unit 1112, and a neural network that is configured to function as the phoneme probability output unit 1113.

The probability update unit 112 updates the character probability CP outputted by the probability output unit 111 (especially, the character probability output unit 1112). For example, the probability update unit 112 may update the character probability CP by updating the probability that a character corresponding to voice at a certain time is a particular character candidate. Here, “updating the probability” may mean “changing (in other words, adjusting) the probability”. In the example embodiment, the probability update unit 112 updates the character probability CP on the basis of the phoneme probability PP outputted by the probability output unit 111 (especially, the phoneme probability output unit 1113) and the dictionary data 121. Since the operation of updating the character probability CP on the basis of the phoneme probability PP and the dictionary data 121 will be described later in detail with reference to FIG. 5 and the like, a description thereof will be omitted here.

When the probability update unit 112 updates the character probability CP, it is preferable that the speech recognition apparatus 1 (especially, the arithmetic apparatus 11) identifies the maximum likelihood character sequence, on the basis of the character probability CP updated by the probability update unit 112, instead of the character probability CP outputted by the probability output unit 111.

The arithmetic apparatus 11 may further perform another process by using a result of the speech recognition process (e.g., at least one of the maximum likelihood character sequence and the maximum likelihood phoneme sequence described above). For example, the arithmetic apparatus 11 may perform a process of translating speech/voice indicated by the speech data into speech/voice in another language or characters, by using the result of the speech recognition process. For example, the arithmetic apparatus 11 may perform a process of converting the speech/voice indicated by the speech data into text (so-called transcribing) by using the result of the speech recognition process. For example, the arithmetic apparatus 11 may perform natural language processing using the result of the speech recognition process, thereby to perform a process of identifying a request of a speaker of the speech/voice and responding to the request. As an example, when the request of the speaker of the speech/voice is a request to know a weather forecast for a certain region, the arithmetic apparatus 11 may perform a process of notifying the speaker of the weather forecast for the region.

The storage apparatus 12 is configured to store desired data. For example, the storage apparatus 12 may temporarily store a computer program to be executed by the arithmetic apparatus 11. The storage apparatus 12 may temporarily store data that are temporarily used by the arithmetic apparatus 11 when the arithmetic apparatus 11 executes the computer program. The storage apparatus 12 may store data that are stored by the speech recognition apparatus 1 for a long time. The storage apparatus 12 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 12 may include a non-transitory recording medium.

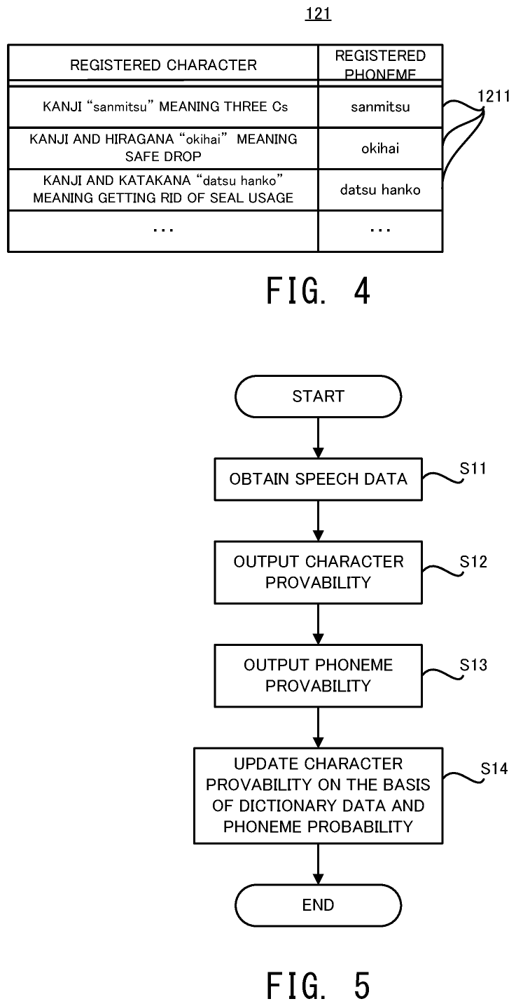

In the example embodiment, the storage apparatus 12 stores the dictionary data 121. The dictionary data 121 are used by the probability update unit 112 to update character probability CP, as described above. FIG. 4 illustrates an example of a data structure of the dictionary data 121. As illustrated in FIG. 4, the dictionary data include at least one dictionary record 1211. In the dictionary record 1211, a character (or a character sequence) and a phoneme (i.e., a reading of the character) of the character are registered. In other words, in the dictionary record 1211, a phoneme (or a phoneme sequence) and a character corresponding to the phoneme (i.e., a character read in the reading indicated by the phoneme) are registered. For this reason, the character and the phoneme registered in the dictionary record 1211 are respectively referred to as a “registered character” and a “registered phoneme”. In this case, it can be said that the dictionary data 121 include the dictionary record 1211 in which the registered character is associated with the registered phoneme. As described in this paragraph, the registered character in the example embodiment may not only mean a single character, but also may mean a character sequence including a plurality of characters. Similarly, the registered phoneme in the example embodiment may not only mean a single phoneme, but also may mean a phoneme sequence including a plurality of phonemes.

In the example illustrated in FIG. 4, the dictionary data 121 include: (i) a first dictionary record 1211 in which a first registered character “sanmitsu” in Japanese Kanji meaning three Cs, i.e., closed spaces, crowds, and close-contact situations, and a first registered phoneme indicating that the reading of the first registered character is “sanmitsu” are registered; (ii) a second dictionary record 1211 in which a second registered character “okihai” in Japanese Kanji and Hiragana meaning safe drop and a second registered phoneme indicating that the reading of the second registered character is “okihai” are registered; and (iii) a third dictionary record 1211 in which a third registered character “datsu hanko” in Japanese Kanji and Katakana meaning getting rid of seal usage and a third registered phoneme indicating that the reading of the third registered character is “datsu hanko” are registered. In other words, in the example illustrated in FIG. 4, the dictionary data 121 include: (i) the first dictionary record 1211 in which the first registered phoneme “sanmitsu” and the first registered character “sanmitsu” in Japanese Kanji meaning three Cs, which is read by the reading indicated by the first registered phoneme, are registered, (ii) the second dictionary record 1211 in which the second registered phoneme “okihai” and the second registered character “okihai” in Japanese Kanji and Hiragana meaning safe drop, which is read by the reading indicated by the second registered phoneme, are registered; and (iii) the third dictionary record 1211 in which the third registered phoneme “datsu hanko” and the third registered phoneme “datsu hanko” in Japanese Kanji and Katakana meaning getting rid of seal usage, which is read by the reading indicated by the third registered phoneme, are registered.

The dictionary data 121 may include such a dictionary record 1211 that a character (including a character sequence) that is not included as the ground truth label in the training data 221 used to learn the parameters of the neural network NN and a phoneme (including a phoneme sequence) corresponding to the character are respectively registered as the registered character and the registered phoneme. That is, the dictionary data 121 may include the dictionary record 1211 in which a character sequence unknown to the neural network NN and a phoneme sequence corresponding to the character sequence are respectively registered as the registered character and the registered phoneme. The registered character and the registered phoneme may be manually registered by a user of the speech recognition apparatus 1. That is, the user of the speech recognition apparatus 1 may manually add the dictionary record 1211 to the dictionary data 121. Alternatively, the registered character and the registered phoneme may be automatically registered by a dictionary registration apparatus that is configured to register the registered character and the registered phoneme in the dictionary data 121. That is, the dictionary registration apparatus may automatically add the dictionary record 1211 to the dictionary data 121.

The dictionary data 121 may not necessarily be stored in the storage apparatus 12. For example, the dictionary data 121 may be recorded on a recording medium that can be read by using a not-illustrated recording medium reading apparatus provided in the speech recognition apparatus 1. The dictionary data 121 may be recorded in an external apparatus (e.g., a server) of the speech recognition apparatus 1.

The communication apparatus 13 is configured to communicate with the external apparatus of the speech recognition apparatus 1 through a not-illustrated communication network. For example, the communication apparatus 13 may be configured to communicate with the external apparatus that stores the computer program to be executed by the arithmetic apparatus 11. Specifically, the communication apparatus 13 may be configured to receive the computer program to be executed by the arithmetic apparatus 11 from the external apparatus. In this case, the arithmetic apparatus 11 may execute the computer program received by the communication apparatus 13. For example, the communication apparatus 13 may be configured to communicate with the external apparatus that stores the speech data. Specifically, the communication apparatus 13 may be configured to receive the speech data from the external apparatus. In this case, the arithmetic apparatus 11 (especially, the probability output unit 111) may output the character probability CP and the phoneme probability PP, on the basis of the speech data received by the communication apparatus 13. For example, the communication apparatus 13 may be configured to communicate with the external apparatus that stores the dictionary data 121. Specifically, the communication apparatus 13 may be configured to receive the dictionary data 121 from the external apparatus. In this case, the arithmetic apparatus 11 (especially, the probability update unit 112) may update the character probability CP, on the basis of the dictionary data 121 received by the communication apparatus 13.

The input apparatus 14 is an apparatus that receives an input of information to the speech recognition apparatus 1 from the outside of the speech recognition apparatus 1. For example, the input apparatus 14 may include an operating apparatus (e.g., at least one of a keyboard, a mouse, and a touch panel) that is operable by an operator of the speech recognition apparatus 1. For example, the input apparatus 14 may include a recording medium reading apparatus that is configured to read information stored as data on a recording medium that can be externally attached to the speech recognition apparatus 1.

The output apparatus 15 is an apparatus that outputs information to the outside of the speech recognition apparatus 1. For example, the output apparatus 15 may output the information as an image. That is, the output apparatus 15 may include a display apparatus (a so-called display) that is configured to display an image indicating the information that is desirably outputted. For example, the output apparatus 15 may output the information as audio. That is, the output apparatus 15 may include an audio apparatus (a so-called speaker) that is configured to output the audio. For example, the output apparatus 15 may output information on a paper surface. That is, the output apparatus 15 may include a print apparatus (a so-called printer) that is configured to print desired information on the paper surface.

### (1-2) Speech Recognition Process by Speech Recognition Apparatus

Next, with reference to FIG. 5, a flow of the speech recognition process performed by the speech recognition apparatus 1 will be described. FIG. 5 is a flowchart illustrating the flow of the speech recognition process performed by the speech recognition apparatus 1.

As illustrated in FIG. 5, the probability output unit 111 (especially, the feature quantity generation unit 1111) obtains the speech data (step S11). For example, when the speech data are stored in the storage apparatus 12, the probability output unit 111 may obtain the speech data from the storage apparatus 12. For example, when the speech data are recorded on the recording medium that can be externally attached to the speech recognition apparatus 1, the probability output unit 111 may obtain the speech data from the recording medium by using the recording medium reading apparatus (e.g., the input apparatus 14) provided in the speech recognition apparatus 1. For example, when the speech data are recorded in the external apparatus (e.g., the server) of the speech recognition apparatus 1, the probability output unit 111 may obtain the speech data from the external apparatus by using the communication apparatus 13. For example, from a recording apparatus (i.e., a microphone) that is configured to record speech/voice, the probability output unit 111 may obtain the speech data indicating the speech/voice recorded by the recording apparatus, by using the input apparatus 14.

Then, the probability output unit 111 outputs the character probability CP, on the basis of the speech data obtained in the step S11 (step S12). Specifically, the feature quantity generation unit 1111 provided in the probability output unit 111 generates the feature quantity of the speech sequence indicated by the speech data, on the basis of the speech data obtained in the step S11. Then, the character probability output unit 1112 provided in the probability output unit 111 outputs the character probability CP, on the basis of the feature quantity generated by the feature quantity generation unit 1111.

In parallel with, or before or after the step S12, the probability output unit 111 outputs the phoneme probability PP, on the basis of the speech data obtained in the step S11 (step S13). Specifically, the feature quantity generation unit 1111 provided in the probability output unit 111 generates the feature quantity of the speech sequence indicated by the speech data, on the basis of the speech data obtained in the step S11. Then, the phoneme probability output unit 1113 provided in the probability output unit 111 outputs the phoneme probability PP, on the basis of the feature quantity generated by the feature quantity generation unit 1111.

The phoneme probability output unit 1113 may output the phoneme probability PP, by using the feature quantity used by the character probability output unit 1112 to output the character probability CP. That is, the feature quantity generation unit 1111 may generate a common feature quantity that is used to output the character probability CP and that is used to output the phoneme probability PP. Alternatively, the phoneme probability output unit 1113 may output the phoneme probability PP, by using a feature quantity that is different from the feature quantity used by the character probability output unit 1112 to output the character probability CP. That is, the feature quantity generation unit 1111 may separately generate the feature quantity used to output the character probability CP and the feature quantity used to output the phoneme probability PP.

Then, the probability update unit 112 updates the character probability CP outputted in the step S12, on the basis of the phoneme probability PP outputted in the step S13 and the dictionary data 121 (step S14).

For this, first, the probability update unit 112 obtains the character probability CP from the probability output unit 111 (especially, the character probability output unit 1112). Furthermore, the probability update unit 112 obtains the phoneme probability PP from the probability output unit 111 (especially, the phoneme probability output unit 1113). In addition, the probability update unit 112 obtains the dictionary data 121 from the storage apparatus 12. When the dictionary data 121 are recorded on the recording medium that can be externally attached to the speech recognition apparatus 1, the probability update unit 112 may obtain the dictionary data 121 from the recording medium, by using the recording medium reading apparatus (e.g., the input apparatus 14) provided in the speech recognition apparatus 1 as. When the dictionary data 121 are recorded in the external apparatus (e.g., the server) of the speech recognition apparatus 1, the probability update unit 112 may obtain the dictionary data 121 from the external apparatus by using the communication apparatus 13.

Then, the probability update unit 112 identifies the most probable phoneme sequence (i.e., the maximum likelihood phoneme sequence), as the phoneme sequence corresponding to the speech sequence indicated by the speech data, on the basis of the phoneme probability PP. Since the method of identifying the maximum likelihood phoneme sequence is already described, a detailed description thereof will be omitted here.

Then, the probability update unit 112 determines whether or not the registered phoneme registered in the dictionary data 121 is included in the maximum likelihood phoneme sequence. When it is determined that the registered phoneme is not included in the maximum likelihood phoneme sequence, the probability update unit 112 may not update the character probability CP. In this case, the arithmetic apparatus 11 identifies the maximum likelihood character sequence, by using the character probability CP outputted by the probability output unit 111. On the other hand, when it is determined that the registered phoneme is included in the maximum likelihood phoneme sequence, the probability update unit 112 updates the character probability CP. In this case, the arithmetic apparatus 11 identifies the maximum likelihood character sequence, by using the character probability CP updated by the probability update unit 112.

In order to update the character probability CP, the probability update unit 112 may identify a time at which the registered phoneme appears in the maximum likelihood phoneme sequence. Then, the probability update unit 112 updates the character probability CP such that the probability of the registered character at the identified time is higher than that before updating the character probability CP. More specifically, the probability update unit 112 updates the character probability CP such that the posterior probability P(W|X) in which the character sequence corresponding to the speech sequence at the identified time is the character sequence W including the registered character, is higher than that before updating the character probability CP. In other words, the probability update unit 112 updates the character probability CP such that the probability that the registered character is included in the character sequence corresponding to the speech sequence at the identified time is higher than that before updating the character probability CP.

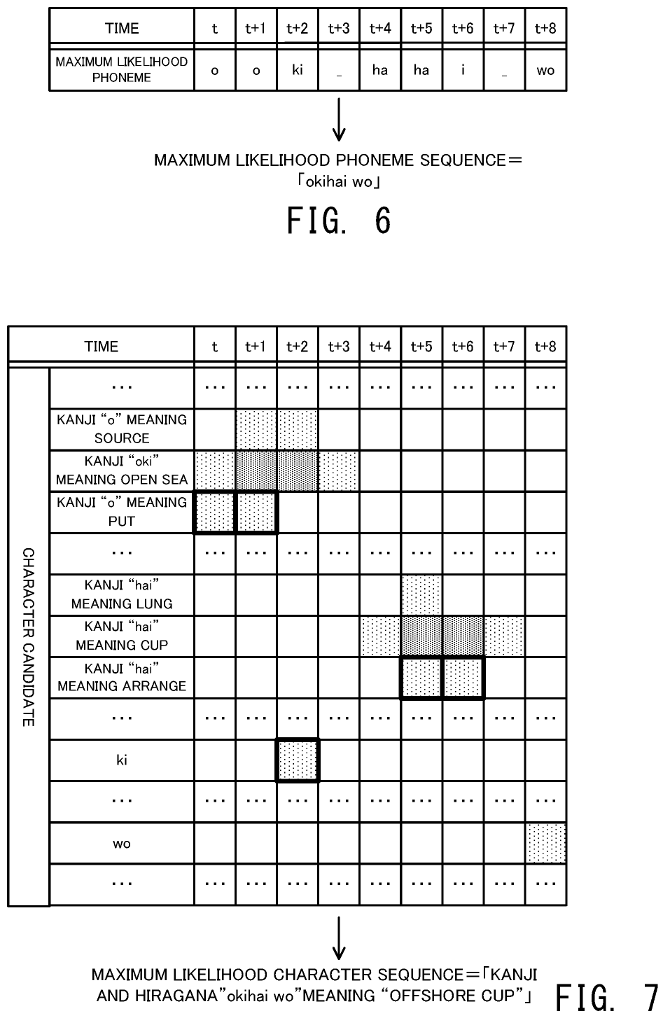

Hereinafter, with reference to FIG. 6 to FIG. 8, a specific example of a process of updating the character probability CP will be described.

FIG. 6 illustrates the maximum likelihood phoneme (i.e., the phoneme with the highest phoneme probability PP) at each of a time t to a time t+8. In this case, as illustrated in FIG. 6, the probability update unit 112 identifies a phoneme sequence “okihai wo”, as the maximum likelihood phoneme sequence.

As illustrated in FIG. 6, the probability update unit 112 may select the same phoneme as the maximum likelihood phoneme at two consecutive times. Especially, when the neural network NN used by the probability output unit 111 is the neural network using CTC, the probability update unit 112 may select the same phoneme as the maximum likelihood phoneme at two consecutive times. Not only in situations when the probability update unit 112 identifies the maximum likelihood phoneme sequence, but also in any situation that the arithmetic apparatus 11 identifies the maximum likelihood phoneme sequence, the arithmetic apparatus 11 may select the same phoneme as the maximum likelihood phoneme at two consecutive times. In this case, the probability update unit 112 (the arithmetic apparatus 11) may ignore one of the two maximum likelihood phonemes selected at two consecutive times when identifying the maximum likelihood phoneme sequence. For example, in the example illustrated in FIG. 6, a maximum likelihood phoneme “0” is selected at each of the time t and the time t+1, but the probability update unit 112 (the arithmetic apparatus 11) may select a phoneme “0”, instead of a phoneme “00”, as a phoneme at the time t and the time t+1, when identifying the maximum likelihood phoneme sequence.

Furthermore, as illustrated in FIG. 6, the probability update unit 112 may set a blank symbol indicating that there is no corresponding phoneme at a certain time. In the example illustrated in FIG. 6, the probability update unit 112 sets a blank symbol represented by a symbol “_”, at the time t+3. The blank symbol may be ignored in the selection of the maximum likelihood phoneme sequence.

Then, the probability update unit 112 determines whether or not the registered phoneme registered in the dictionary data 121 illustrated in FIG. 4 is included in the maximum likelihood phoneme sequence “okihai wo”. In the example of the dictionary data 121 illustrated in FIG. 4, the registered phoneme “sanmitsu”, the registered phoneme “okihai”, and the registered phoneme “datsu hanko” are registered in the dictionary data 121. In this case, the probability update unit 112 determines whether or not at least one of the registered phoneme “sanmitsu”, the registered phoneme “okihai” and the registered phoneme “datsu hanko” is included in the maximum likelihood phoneme sequence.

As a result, the probability update unit 112 determines that the registered phoneme “okihai” is included in the maximum likelihood phoneme sequence “okihai wo”. Therefore, in this case, the probability update unit 112 updates the character probability CP. Specifically, the probability update unit 112 identifies that the times at which the registered phoneme appears in the maximum likelihood phoneme sequence are the time t to the time t+6. Then, the probability update unit 112 updates the character probability CP such that the probability of the registered character at the specified times t to t+6 is higher than that before updating the character probability CP.

For example, FIG. 7 illustrates the character probability CP before the update by the probability update unit 112. In the example illustrated in FIG. 7, before the probability update unit 112 updates the character probability CP, the arithmetic apparatus 11 identifies not a correct character sequence “okihai wo” in Japanese Kanji and Hiragana meaning safe drop (i.e., a natural character sequence), but an incorrect character sequence “okihai wo” in Japanese Kanji and Hiragana meaning offshore cup (i.e., an unnatural character sequence), as the maximum likelihood character sequence, on the basis of the character probability CP. One of the reasons for identifying the incorrect character sequence is that the training data 221 used to learn the parameters of the neural network NN do not include the correct character sequence. In the example illustrated in FIG. 7, the training data 221 do not include the correct character sequence “okihai” in Japanese Kanji and Hiragana meaning safe drop, which is one of the reasons for identifying the incorrect character sequence.

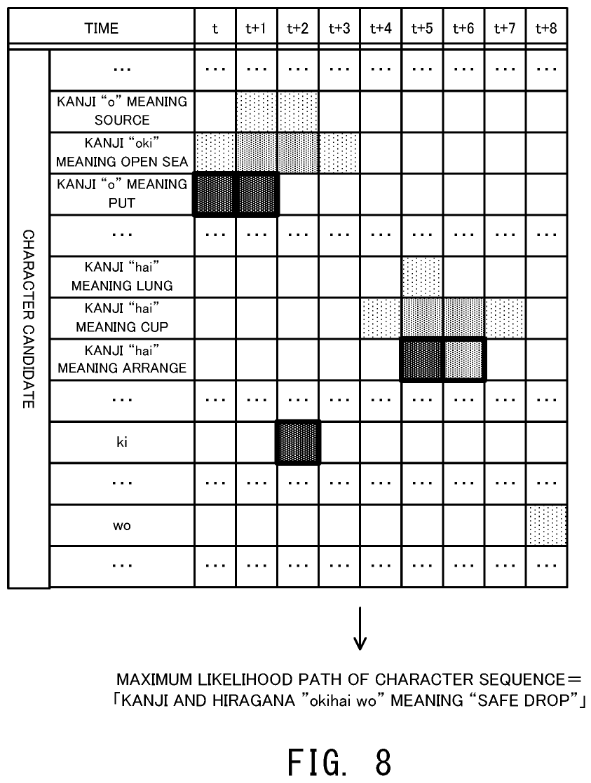

In this case, the probability update unit 112 updates the character probability CP such that the probability of character candidates included in the registered character (in other words, each of a character candidate “o” in Japanese Kanji meaning put, a character candidate “ki”, and a character candidate “hai” in Japanese Kanji meaning arrange) is high in the times t to t+6 in which the registered phoneme is included in the maximum likelihood phoneme sequence. Specifically, the probability update unit 112 may identify a path of the character candidates (a path of the probability) in which the maximum likelihood character sequence is the character sequence including the registered character, on the basis of the character probability CP. When there are a plurality of paths of the character candidates in which the maximum likelihood character sequence is the character sequence including the registered character, the probability update unit 112 may identify the maximum likelihood path from the plurality of paths. In the example illustrated in FIG. 7, the probability update unit 112 may identify such a path of the character candidates that the character candidate “o” in Japanese Kanji meaning put is selected in the time t to the time t+1, the character candidate “ki” is selected at the time t+2, and the character candidate “hai” in Japanese Kanji meaning arrange is selected in the time t+5 to the time t+6. Then, the probability update unit 112 may update the character probability CP such that the probability corresponding to the identified pass is higher than that before updating the character probability CP. In the example illustrated in FIG. 7, the probability update unit 112 may update the character probability CP such that the probability that the character corresponding to the voice in the time t to the time t+1 is the character candidate “o” in Japanese Kanji meaning put is higher than that before updating the character probability CP, such that the probability that the character corresponding to the voice at the time t+2 is the character candidate “ki” is higher than that before updating the character probability CP, and such that the probability that the character corresponding to the voice in the time t+5 to the time t+6 is the character candidate “hai” in Japanese Kanji meaning arrange is higher than that before updating the character probability CP. For example, the probability update unit 112 may update the character probability CP such that the character probability CP illustrated in FIG. 7 changes to the character probability CP illustrated in FIG. 8. Consequently, after the probability update unit 112 updates the character probability CP, the arithmetic apparatus 11 is likely to identify not the incorrect character sequence “okihai wo” in Japanese Kanji and Hiragana meaning offshore cup (i.e., the unnatural character sequence), but the correct character sequence “okihai wo” in Japanese Kanji and Hiragana meaning safe drop (i.e., the natural character sequence), as the maximum likelihood character sequence. That is, the arithmetic apparatus 11 is more likely to identify the correct character sequence (i.e., the natural character sequence), as the maximum likelihood character sequence. The probability update unit 112 may update the character probability CP such that the probability of the character candidates included in the registered character is higher by a desired amount. In the example illustrated in FIG. 7, the probability update unit 112 may update the character probability CP such that the probability that the character corresponding to the voice in the time t to the time t+1 is the character candidate “o” in Japanese Kanji meaning put is higher, by a first determined amount, than that before updating the character probability CP, such that the probability that the character corresponding to the voice at the time t+2 is the character candidate “ki” is higher, by a second desired amount that is the same as or different from the first desired amount, than that before updating the character probability CP, and such that the probability that the character corresponding to the voice in the time t+5 to the time t+6 is the character candidate “hai” in Japanese Kanji meaning arrange is higher, by a third desired amount that is the same as or different from at least one of the first and second desired amounts, than that before updating the character probability CP As an example, the probability update unit 112 may update the character probability CP such that the probability of the character candidates included in the registered character is higher by a predetermined amount that is determined in accordance with the probability of the phoneme candidates corresponding to the registered phoneme (specifically, the registered phoneme included in the maximum likelihood phoneme sequence). Specifically, the probability update unit 112 may calculate an average or mean value of the probability of the phoneme candidates corresponding to the registered phoneme. In the example illustrated in FIG. 6, the probability update unit 112 may calculate the average or mean value of (i) the probability that the phoneme corresponding to the voice at the time t is the phoneme candidate “o” corresponding to the registered phoneme, (ii) the probability that the phoneme corresponding to the voice at the time t+1 is the phoneme candidate “o” corresponding to the registered phoneme, (iii) the probability that the phoneme corresponding to the voice at the time t+2 is the phoneme candidate “ki” corresponding to the registered phoneme, (iv) the probability that the phoneme corresponding to the voice at the time t+4 is the phoneme candidate “ha” corresponding to the registered phoneme, (v) the probability that the phoneme corresponding to the voice at the time t+5 is the phoneme candidate “ha” corresponding to the registered phoneme, and (vi) the probability that the phoneme corresponding to the voice at the time t+6 is the phoneme candidate “ha” corresponding to the registered phoneme. Then, the probability update unit 112 may update the character probability CP such that the probability of the character candidates included in the registered character is higher by a desired amount that is determined in accordance with the calculated average or mean value of the probability. For example, the probability update unit 112 may update the character probability CP such that the probability of the character candidates included in the registered character is higher by a desired amount corresponding to a constant multiple of the calculated average or mean value of the probability.

### (1-3) Technical Effect of Speech Recognition Apparatus 1

As described above, the speech recognition apparatus 1 according to the example embodiment updates the character probability CP on the basis of the phoneme probability PP and the dictionary data 121. Therefore, the registered character registered in the dictionary data 121 is reflected in the character probability CP. Consequently, the speech recognition apparatus 1 is more likely to output the character probability CP that allows the identification of the maximum likelihood character sequence including the registered character, as compared with the case where the character probability CP is not updated on the basis of the dictionary data 121. Therefore, the speech recognition apparatus 1 is more likely to output the character probability CP that allows the identification of the correct character sequence (i.e., the natural character sequence), as the maximum likelihood character sequence, as compared with the case where the character probability CP is not updated on the basis of the dictionary data 121. In other words, the speech recognition apparatus 1 is less likely to be capable of outputting the character probability CP that causes the identification of the incorrect character sequence (i.e., the unnatural character sequence), as the maximum likelihood character sequence, as compared with the case where the character probability CP is not updated on the basis of the dictionary data 121. Consequently, the speech recognition apparatus 1 is more likely to be capable of identifying the correct character sequence (i.e., the natural character sequence), as the maximum likelihood character sequence, as compared with the case where the character probability CP is not updated on the basis of the dictionary data 121.

Especially, since the speech recognition apparatus 1 updates the character probability CP on the basis of the dictionary data 121, even when the training data 221 for learning the parameters of the neural network NN do not include the character sequence including the registered character, the speech recognition apparatus 1 is likely to be capable of outputting the character probability CP that allows the identification of the correct character sequence (i.e., the natural character sequence), as the maximum likelihood character sequence. In other words, the speech recognition apparatus 1 is likely to be capable of outputting the character probability CP that allows the identification of the character sequence unknown (i.e., not yet learned) to the neural network NN, as the maximum likelihood character sequence. If the character probability CP is not updated on the basis of the dictionary data 121, in order that the speech recognition apparatus 1 outputs the character probability CP that allows the identification of the character sequence that is not included in the training data 221, as the maximum likelihood character sequence, the speech recognition apparatus 1 needs to learn the parameters of the neural network NN by using the training data 221 including the character sequence unknown (i.e., not yet learned) to the neural network NN, as the ground truth label. It is, however, not always easy to re-learn the parameters of the neural network NN, because a cost is high to learn the parameters of the neural network NN. In the example embodiment, however, without requiring the re-learning of the parameters of the neural network NN, the speech recognition apparatus 1 is configured to output the character probability CP that allows the identification of the character sequence unknown (i.e., not yet learned) to the neural network NN, as the maximum likelihood character sequence. That is, the speech recognition apparatus 1 is configured to identify the character sequence unknown (i.e., not yet learned) to the neural network NN, as the maximum likelihood character sequence.

The speech recognition apparatus 1 updates the character probability CP such that the probability of the character candidates that constitute the registered character corresponding to the registered phoneme is high when the registered phoneme is included in the maximum likelihood phoneme sequence. For this reason, the speech recognition apparatus 1 is likely to be capable of outputting the character probability CP that allows the identification of the character sequence including the registered character, as the maximum likelihood character sequence. That is, the speech recognition apparatus 1 is likely to be capable of identifying the character sequence including the registered character, as the maximum likelihood character sequence.

The speech recognition apparatus 1 performs the speech recognition process, by using the neural network NN including the first network part NN1 that is configured to function as the feature quantity generation unit 1111, the second network part NN2 that is configured to function as the character probability output unit 1112, and the third network part NN3 that is configured to function as the phoneme probability output unit 1113. Therefore, in the introduction of the neural network NN, if there is an existing neural network that includes the first network part NN1 and the second network part NN2, but that does not include the third network part NN3, then, it is possible to construct the neural network NN by adding the third network part NN3 to the existing neural network.

### (1-4) Modified Examples of Speech Recognition Apparatus 1

In the above description, the probability update unit 112 determines whether or not the registered phoneme registered in the dictionary data 121 is included in the maximum likelihood phoneme sequence, in order to update the character probability CP. The probability update unit 112, however, may further identify at least one second probable phoneme sequence next to the maximum likelihood phoneme sequence, as the phoneme sequence corresponding to the speech sequence indicated by the speech data, in addition to the maximum likelihood phoneme sequence, on the basis of the phoneme probability PP. That is, the probability update unit 112 may identify a plurality of probable phoneme sequences, as the phoneme sequence corresponding to the speech sequence indicated by the speech data, on the basis of the phoneme probability PP. For example, the probability update unit 112 may identify the plurality of phoneme sequences by using a beam-search method. When identifying the plurality of phoneme sequences in this way, the probability update unit 112 may determine whether or not the registered phoneme is included in each of the plurality of phoneme sequences. In this case, when it is determined that the registered phoneme is included in at least one of the plurality of phoneme sequences, the probability update unit 112 may identify the time at which the registered phoneme appears in at least one phoneme sequence that is determined to include the registered phoneme, and may update the character probability CP such that the probability of the registered character is high at the identified time. Consequently, the character probability CP is more likely to be updated, as compared with the case where it is determined whether or not the registered phoneme is included in a single maximum likelihood phoneme sequence. That is, it is likely that the registered character registered in the dictionary data 121 is reflected in the character probability CP. Consequently, the arithmetic apparatus 11 is likely to be capable of outputting the natural maximum likelihood character sequence. The above description describes the speech recognition apparatus 1 that performs the speech recognition process by using the speech data indicating the Japanese speech sequence. The speech recognition apparatus 1, however, may perform the speech recognition process by using the speech data indicating the speech sequence in the language that is different from Japanese. Even in this case, the speech recognition apparatus 1 may output the character probability CP and the phoneme probability PP on the basis of the speech data, and may update the character probability CP on the basis of the phoneme probability PP and the dictionary data 121. Consequently, even when performing the speech recognition process by using the speech data indicating the speech sequence in the language that is different from Japanese, the speech recognition apparatus 1 is allowed to enjoy the same effects as those when performing the speech recognition process by using the speech data indicating the Japanese speech sequence.

As an example, the speech recognition apparatus 1 may perform the speech recognition process by using the speech data indicating a speech sequence in a language using alphabet letters (e.g., at least one of English, German, French, Spanish, Italian, Greek, and Vietnamese). In this case, the character probability CP may indicate the probability of a character sequence corresponding to the arrangement of alphabet letters (so-called spelling). More specifically, the character probability CP may indicate a posterior probability P(W|X) in which when the feature quantity of the speech sequence indicated by the speech data is X, the character sequence corresponding to the speech sequence is a character sequence W corresponding to the arrangement of certain alphabet letters. On the other hand, the phoneme probability PP may indicate the probability of a phoneme sequence corresponding to the arrangement of phonetic symbols. More specifically, the phoneme probability PP may indicate a posterior probability P(S|X) in which when the feature quantity of the speech sequence indicated by the speech data is X, the phoneme sequence corresponding to the speech sequence is a phoneme sequence S corresponding to the arrangement of certain phonetic symbols.

As another example, the speech recognition apparatus 1 may perform the speech recognition process by using the speech data indicating a Chinese speech sequence. In this case, the character probability CP may indicate the probability of a character sequence corresponding to the arrangement of Chinese characters. More specifically, the character probability CP may indicate a posterior probability P(W|X) in which when the feature quantity of the speech sequence indicated by the speech data is X, the character sequence corresponding to the speech sequence is a character sequence W corresponding to the arrangement of certain Chinese characters. On the other hand, the phoneme probability PP may indicate the probability of a phoneme sequence corresponding to the arrangement of Pinyin characters. More specifically, the phoneme probability PP may indicate a posterior probability P(S|X) in which when the feature quantity of the speech sequence indicated by the speech data is X, the phoneme sequence corresponding to the speech sequence is a phoneme sequence S corresponding to the arrangement of certain Pinyin characters.

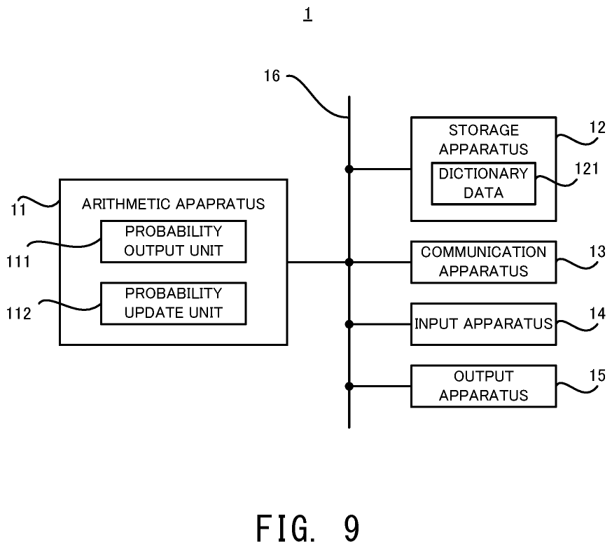

In the above description, the probability output unit 111 provided in the speech recognition apparatus 1 outputs the character probability CP and the phoneme probability PP, by using the neural network NN including the feature quantity generation unit 1111, the character probability output unit 1112, and the phoneme probability output unit 1113. As illustrated in FIG. 9, however, the probability output unit 111 may output the character probability CP and the phoneme probability PP without using the neural network NN including the feature quantity generation unit 1111, the character probability output unit 1112, and the phoneme probability output unit 1113. That is, the probability output unit 111 may output the character probability CP and the phoneme probability PP by using any neural network that is configured to output the character probability CP and the phoneme probability PP on the basis of the speech data.

### (2) Learning Apparatus 2 in Example Embodiment

Next, the learning apparatus 2 in the example embodiment will be described. The learning apparatus 2 performs a learning process for learning the parameters of the neural network NN used by the speech recognition apparatus 1 to output the character probability CP and the phoneme probability PP. The speech recognition apparatus 1 outputs the character probability CP and the phoneme probability PP, by using the neural network NN to which the parameters learned by the learning apparatus 2 are applied.

A configuration of the learning apparatus 2 will be described with reference to FIG. 10. FIG. 10 is a block diagram illustrating the configuration of the learning apparatus 2 according to the example embodiment.

As illustrated in FIG. 10, the learning apparatus 2 includes an arithmetic apparatus 21 and a storage apparatus 22. Furthermore, the learning apparatus 2 may include a communication apparatus 23, an input apparatus 24, and an output apparatus 25. The learning apparatus 2, however, may not include the communication apparatus 23. The learning apparatus 2 may not include the input apparatus 24. The learning apparatus 2 may not include the output apparatus 25. The arithmetic apparatus 21, the storage apparatus 22, the communication apparatus 23, the input apparatus 24, and the output apparatus 25 may be connected through a data bus 26.

The arithmetic apparatus 21 may include, for example, a CPU. The arithmetic apparatus 21 may include, for example, a GPU in addition to or instead of the CPU. The arithmetic apparatus 21 may include, for example, a FPGA in addition to or instead of at least one of the CPU and the GPU. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a recording medium reading apparatus provided in the learning apparatus 2 (e.g., the input apparatus 24 described later). The arithmetic apparatus 21 may obtain (i.e., read) a computer program from a not-illustrated apparatus (e.g., a server) disposed outside the learning apparatus 2, through the communication apparatus 23. That is, the arithmetic apparatus 21 may download a computer program. The arithmetic apparatus 21 executes the read computer program. Consequently, a logical functional block for performing an operation to be performed by the learning apparatus 2 (e.g., the above-described learning process) is realized or implemented in the arithmetic apparatus 21. That is, the arithmetic apparatus 21 is allowed to function as a controller for realizing or implementing the logical function block for performing the process to be performed by the learning apparatus 2.

FIG. 10 illustrates an example of the logical functional block realized or implemented in the arithmetic apparatus 21 to perform the learning process. As illustrated in FIG. 10, in the arithmetic apparatus 21, a training data acquisition unit 211 that is a specific example of an “acquisition unit” and a learning unit 212 that is a specific example of a “learning unit” are realized or implemented.

The training data acquisition unit 211 obtains the training data 221 that are used to learn the parameters of the neural network NN. For example, when the training data 221 are stored in the storage apparatus 22 as illustrated in FIG. 10, the training data acquisition unit 211 may obtain the training data 221 from the storage apparatus 22. For example, when the training data 221 are recorded on a recording medium that can be externally attached to the learning apparatus 2, the training data acquisition unit 211 may obtain the training data 221 from the recording medium by using the recording medium reading apparatus (e.g., the input apparatus 24) provided in the learning apparatus 2. For example, when the training data 221 are recorded in an external apparatus (e.g., a server) of the learning apparatus 2, the training data acquisition unit 211 may obtain the training data 221 from the external apparatus by using the communication apparatus 23.

FIG. 11 illustrates an example of the data structure of the training data 221. As illustrated in FIG. 11, the training data 221 include at least one learning record 2211. The learning record 2211 includes speech data for learning, a ground truth label of a character sequence corresponding to a speech sequence indicated by the speech data for learning, and a ground truth label of a phoneme sequence corresponding to the speech sequence indicated by the speech data for learning

The learning unit 212 learns the parameters of the neural network NN by using the training data 221 obtained by the training data acquisition unit 211. Consequently, the learning unit 212 is allowed to construct the neural network NN that is capable of outputting an appropriate character probability CP and an appropriate phoneme probability PP when the speech data are inputted.

Specifically, the learning unit 212 inputs the speech data for learning included in the training data 221, to the neural network NN (or a neural network for learning that imitates the neural network NN, and the same shall apply hereinafter). Consequently, the neural network NN outputs the character probability CP that is the probability of the character sequence corresponding to the speech sequence indicated by the speech data for learning, and the phoneme probability PP that is the probability of the phoneme sequence corresponding to the speech sequence indicated by the speech data for learning. As described above, since the maximum likelihood character sequence is identified from the character probability CP and the maximum likelihood phoneme sequence is identified from the phoneme probability PP, the neural network NN may be considered to substantially output the maximum likelihood character sequence and the maximum likelihood phoneme sequence.

Then, the learning unit 212 adjusts the parameters of the neural network NN, by using a loss function based on a character sequence error that is an error between the maximum likelihood character sequence outputted by the neural network NN and the ground truth label of the character sequence included in the training data 221 and based on a phoneme sequence error that is an error between the maximum likelihood phoneme sequence outputted by the neural network NN and the ground truth label of the phoneme sequence included in the training data 221. For example, when used is such a loss function that decreases as the character sequence error decreases and that decreases as the phoneme sequence error decreases, the learning unit 212 may adjust the parameters of the neural network NN to reduce (preferably, to minimize) the loss function.

The learning unit 212 may adjust the parameters of the neural network NN by using an existing algorithm for learning the parameters of the neural network NN. For example, the learning unit 212 may adjust the parameters of the neural network NN by using error back-propagation.

As described above, the neural network NN may include the first network part NN1 that is configured to function as the feature quantity generation unit 1111, the second network part NN2 that is configured to function as the character probability output unit 1112, and the third network part NN3 that is configured to function as the phoneme probability output unit 1113. In this case, the learning unit 212 may learn at least one parameter of the first network part NN1 to the third network part NN3, and then may learn at least another parameter of the first network part NN1 to the third network part NN3, with the learned parameters fixed. For example, the learning unit 212 may learn the parameters of the first network part NN1 and the second network part NN2, and then may learn the parameters of the third network part NN3, with the learned parameters fixed. Specifically, the learning unit 212 may learn the parameters of the first network part NN1 and the second network part NN2 by using the speech data for learning and the ground truth label of the character sequence of the training data 221. Then, the learning unit 212 may learn the parameters of the third network part NN3 by using the speech data for learning and the ground truth label of the phoneme sequence of the training data 221, with the parameters of the first network part NN1 and the second network part NN2 fixed. In this case, in the introduction of the neural network NN, if there is an existing neural network that includes the first network part NN1 and the second network part NN2, but that does not include the third network part NN3, then, the learning apparatus 2 is allowed to separately learn the parameters of the existing neural network and the third network part NN3. The learning apparatus 2 is configured to learn the parameters of the existing neural network, and then to selectively learn the parameters of the third network part NN3, with the third network part NN3 added to the learned existing neural network.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the learning apparatus 2 for a long time. The storage apparatus 22 may include at least one of a RAM, a ROM, a hard disk apparatus, a magneto-optical disk apparatus, a SSD, and a disk array apparatus. That is, the storage apparatus 22 may include a non-transitory recording medium.

The communication apparatus 23 is configured to communicate with the external apparatus of the learning apparatus 2 through a not-illustrated communication network. For example, the communication apparatus 23 may be configured to communicate with the external apparatus that stores the computer program to be executed by the arithmetic apparatus 21. Specifically, the communication apparatus 23 may be configured to receive the computer program to be executed by the arithmetic apparatus 21 from the external apparatus. In this case, the arithmetic apparatus 21 may execute the computer program received by the communication apparatus 23. For example, the communication apparatus 23 may be configured to communicate with the external apparatus that stores the training data 221. Specifically, the communication apparatus 23 may be configured to receive the training data 221 from the external apparatus.

The input apparatus 24 is an apparatus that receives an input of information to the learning apparatus 2 from the outside of the learning apparatus 2. For example, the input apparatus 24 may include an operating apparatus (e.g., at least one of a keyboard, a mouse, and a touch panel) that is operable by an operator of the learning apparatus 2. For example, the input apparatus 24 may include a recording medium reading apparatus that is configured to read information stored as data on the recording medium that can be externally attached to the learning apparatus 2. The output apparatus 25 is an apparatus that outputs information to the outside of the learning apparatus 2. For example, the output apparatus 25 may output the information as an image. That is, the output apparatus 25 may include a display apparatus (a so-called display) that is configured to display an image indicating the information that is desirably outputted. For example, the output apparatus 25 may output the information as audio. That is, the output apparatus 25 may include an audio apparatus (a so-called speaker) that is configured to output the audio. For example, the output apparatus 25 may output information on a paper surface. That is, the output apparatus 25 may include a print apparatus (a so-called printer) that is configured to print desired information on the paper surface. The speech recognition apparatus 1 may function as the learning apparatus 2.

For example, the arithmetic apparatus 11 of the speech recognition apparatus 1 may include the training data acquisition unit 211 and the learning unit 212. In this case, the speech recognition apparatus 1 may learn the parameters of the neural network NN.

### (3) Supplementary Notes

With respect to the example embodiment described above, the following Supplementary Notes are further disclosed.

### [Supplementary Note 1]

A speech recognition apparatus including:

an output unit that outputs a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and an update unit that updates the first probability on the basis of the second probability and dictionary data in which a registered character is associated with a registered phoneme that is a phoneme of the registered character.

### [Supplementary Note 2]

The speech recognition apparatus according to Supplementary Note 1, wherein the update unit updates the first probability such that a probability that the registered character is included in the character sequence is higher than a probability before the first probability is updated, when the registered phoneme is included in the phoneme sequence.

### [Supplementary Note 3]

The speech recognition apparatus according to Supplementary Note 1 or 2, wherein the neural network includes:

a first network part that outputs a feature quantity of the speech sequence when the speech data are inputted;

a second network part that outputs the first probability when the feature quantity is inputted; and

a third network part that outputs the second probability when the feature quantity is inputted.

### [Supplementary Note 4]

A learning apparatus including:

an acquisition unit that obtains training data including first speech data for learning, a ground truth label of a first character sequence corresponding to a first speech sequence indicated by the first speech data, and a ground truth label of a first phoneme sequence corresponding to the first speech sequence; and

a learning unit that learns parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

### [Supplementary Note 5]

The learning apparatus according to Supplementary Note 4, wherein the neural network includes:

a first model that outputs a feature quantity of the speech sequence when the second speech data are inputted;

a second model that outputs the first probability when the feature quantity is inputted; and

a third model that outputs the second probability when the feature quantity is inputted Including, and

the learning unit learns parameters of the first and second models by using the first speech data and the ground truth label of the first character sequence of the training data, and then learns parameters of the third model by using the first speech data and the ground truth label of the first phoneme sequence of the training data.

### [Supplementary Note 6]

A speech recognition method including:

outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and

updating the first probability on the basis of the second probability and dictionary data in which a registered character is associated with a registered phoneme that is a phoneme of the registered character.

### [Supplementary Note 7]

A learning method including:

obtaining training data including first speech data for learning, a ground truth label of a first character sequence corresponding to a first speech sequence indicated by the first speech data, and a ground truth label of a first phoneme sequence corresponding to the first speech sequence; and

learning parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

### [Supplementary Note 8]

A recording medium on which a computer program that allows a computer to execute a speech recognition method is recorded,

the speech recognition method including:

outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and

updating the first probability on the basis of the second probability and dictionary data in which a registered character is associated with a registered phoneme that is a phoneme of the registered character.

### [Supplementary Note 9]

A recording medium on which a computer program that allows a computer to execute a learning method is recorded,

the learning method including:

obtaining training data including first speech data for learning, a ground truth label of a first character sequence corresponding to a first speech sequence indicated by the first speech data, and a ground truth label of a first phoneme sequence corresponding to the first speech sequence; and

learning parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

### [Supplementary Note 10]

A computer program that allows a computer to execute a speech recognition method,

the speech recognition method including:

outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and

updating the first probability on the basis of the second probability and dictionary data in which a registered character is associated with a registered phoneme that is a phoneme of the registered character.

### [Supplementary Note 11]

A computer program that allows a computer to execute a learning method,

the learning method including:

obtaining training data including first speech data for learning, a ground truth label of a first character sequence corresponding to a first speech sequence indicated by the first speech data, and a ground truth label of a first phoneme sequence corresponding to the first speech sequence; and

learning parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

At least a part of the constituent components of the above-described example embodiment can be combined with at least another part of the constituent components of the above-described example embodiment, as appropriate. A part of the constituent components of the above-described example embodiment may not be used. Furthermore, to the extent permitted by law, all the references (e.g., publications) cited in this disclosure are incorporate by reference as a part of the description of this disclosure.

This disclosure is not limited to the examples described above and is allowed to be changed, if desired, without departing from the essence or spirit of this disclosure which can be read from the claims and the entire identification. A speech recognition apparatus, a speech recognition method, a learning apparatus, a learning method, and a recording medium with such changes are also intended to be within the technical scope of this disclosure.

### DESCRIPTION OF REFERENCE CODES

1 Speech recognition apparatus
11 Arithmetic apparatus
111 Probability output unit
1111 Feature quantity generation unit
1112 Character probability output unit
1113 Phoneme probability output unit
12 Storage apparatus
121 Dictionary data
1211 Dictionary record
2 Learning apparatus
21 Arithmetic apparatus
211 Training data acquisition unit
212 Learning unit 22 Storage apparatus
221 Training data
NN Neural network
NN1 First network part
NN2 Second network part
NN3 Third network part
CP character probability
PP phoneme probability

What is claimed is:

1. A speech recognition apparatus comprising:
at least one memory configured to store instructions; and
at least one processor configured to execute the instructions to:
output a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and
update the first probability on the basis of the second probability and dictionary data in which a registered character is associated with a registered phoneme that is a phoneme of the registered character.

2. The speech recognition apparatus according to claim 1, wherein the at least one processor is configured to execute the instructions to update the first probability such that a probability that the registered character is included in the character sequence is higher than a probability before the first probability is updated, when the registered phoneme is included in the phoneme sequence.

3. The speech recognition apparatus according to claim 1, wherein the neural network includes:
a first network part that outputs a feature quantity of the speech sequence when the speech data are inputted;
a second network part that outputs the first probability when the feature quantity is inputted; and
a third network part that outputs the second probability when the feature quantity is inputted.

4. A learning apparatus comprising:
at least one memory configured to store instructions; and
at least one processor configured to execute the instructions to:
obtain training data including first speech data for learning, a ground truth label of a first character sequence corresponding to a first speech sequence indicated by the first speech data, and a ground truth label of a first phoneme sequence corresponding to the first speech sequence; and
learn parameters of a neural network that outputs a first probability that is a probability of a second character sequence corresponding to a second speech sequence indicated by second speech data and a second probability that is a probability of a second phoneme sequence corresponding to the second speech sequence when the second speech data are inputted, by using the training data.

5. The learning apparatus according to claim 4, wherein the neural network includes:
a first model that outputs a feature quantity of the speech sequence when the second speech data are inputted;
a second model that outputs the first probability when the feature quantity is inputted; and
a third model that outputs the second probability when the feature quantity is inputted Including, and
the at least one processor is configured to execute the instructions to learn parameters of the first and second models by using the first speech data and the ground truth label of the first character sequence of the training data, and then learn parameters of the third model by using the first speech data and the ground truth label of the first phoneme sequence of the training data.

6. A speech recognition method comprising:
outputting a first probability that is a probability of a character sequence corresponding to a speech sequence indicated by speech data and a second probability that is a probability of a phoneme sequence corresponding to the speech sequence, by using a neural network that outputs the first probability and the second probability, when the speech data are inputted; and
updating the first probability on the basis of the second probability and dictionary data in which a registered character is associated with a registered phoneme that is a phoneme of the registered character.

7-9. (canceled)
